(19) United States
(12) Patent Application Publication
(10) Pub. No.: US 2026/0046608 A1
(43) Pub. Date: Feb. 12, 2026

(54) METHOD, APPARATUS AND SYSTEM FOR TRANSMITTING AND RECEIVING TERMINAL CAPABILITY INFORMATION

(71) Applicant: Beijing Xiaomi Mobile Software Co., Ltd., Beijing (CN)

(72) Inventors: Juan ZHANG, Beijing (CN); Xueyuan GAO, Beijing (CN)

(73) Assignee: Beijing Xiaomi Mobile Software Co., Ltd., Beijing (CN)

(21) Appl. No.: 19/102,100

(22) PCT Filed: Aug. 9, 2022
(86) PCT No.: PCT/CN2022/111255

§ 371 Date: Feb. 7, 2025

(51) Int. Cl. H04W 8/22; H04L 5/00

(52) U.S. Cl. CPC H04W 8/22; H04L 5/0048

(57) ABSTRACT

A method of transmitting terminal capability information includes: transmitting terminal capability information to a network device, wherein the terminal capability information indicates whether the terminal supports a capability of transmitting a plurality of beams simultaneously.

### CROSS-REFERENCE TO RELATED APPLICATION

This application is the U.S. national phase application of International Application No. PCT/CN2022/111255, filed on Aug. 9, 2022, the disclosure of which is incorporated herein by reference in its entirety for all purposes.

### TECHNICAL FIELD

The present disclosure relates to the field of wireless communication technologies, and in particular, relates to a method, apparatus and system for transmitting or receiving terminal capability information.

### BACKGROUND

In a new radio (NR) system, multi-point coordination is adopted to improve cell-edge coverage and provide a more balanced service quality within a service cell.

A millimeter wave band, which generally refers to electromagnetic waves with a wavelength of 1-10 mm, is increasingly being used and due to its very short wavelength, a blocking effect of various obstacles is becoming more significant. In this case, from a perspective of ensuring a link connection robustness, multiple beams may be transmitted at multiple angles via a collaboration between multiple transmission-reception points (TRPs) or panels, thereby reducing an adverse influence of the blocking effect. In some implementations, a terminal can only transmit or receive one beam on the same antenna panel for uplink data or downlink data. In other implementations, by being enhanced in the downlink direction, the terminal can receive beams in multiple different directions from different TRPs simultaneously on multiple antenna panels. In some possible implementations, it is desired that the terminal can transmit different beams simultaneously on multiple antenna panels in the uplink direction.

Different terminals may have different transmission capabilities, so it is unable to achieve accurate scheduling when a network device schedules different terminals.

### SUMMARY

The present disclosure provides a method, apparatus and system for transmitting or receiving capability information.

In a first aspect, a method for transmitting terminal capability information is provided, which is performed by a terminal, and the method includes: transmitting terminal capability information to a network device, wherein the terminal capability information indicates whether the terminal supports a capability of transmitting a plurality of beams simultaneously.

In a second aspect, a method for receiving terminal capability information is provided, which is performed by a network device, and the method includes: receiving terminal capability information transmitted by a terminal, wherein the terminal capability information indicates whether the terminal supports a capability of transmitting a plurality of beams simultaneously.

In a third aspect, a communication device is provided, including one or more processor and one or more memory, wherein the one or more memories are configured to store a computer program; and wherein the one or more processors are configured to execute the computer program to cause the communication device to transmit terminal capability information to a network device, wherein the terminal capability information indicates whether the terminal supports a capability of transmitting a plurality of beams simultaneously.

In the present disclosure, terminals report a terminal capability to a network device, so that the network device knows whether each terminal has a capability of transmitting multiple beams simultaneously. Therefore, the network device can configure transmission parameters matching the terminal capability for the terminal, which improves scheduling effectiveness and saves network resources.

### BRIEF DESCRIPTION OF THE DRAWINGS

The drawings described herein are used to provide further understanding of embodiments of the present disclosure and constitute a part of the present disclosure. The illustrated examples of the embodiments of the present disclosure and their descriptions are used to explain the embodiments of the present disclosure and do not constitute improper limitations on the embodiments of the present disclosure.

The accompanying drawings, which are incorporated in and constitute a part of this specification, illustrate the examples consistent with the embodiments of the present disclosure and, together with the description, serve to explain the principles of the embodiments of the present disclosure.

FIG. 1 is a schematic structural diagram of a wireless communication system provided in an example of the present disclosure.

FIG. 2 is a flowchart of a method for transceiving terminal capability information provided in an example of the present disclosure.

FIG. 3 is a structural diagram of an apparatus for transmitting terminal capability information provided in an example of the present disclosure.

FIG. 4 is a structural diagram of an apparatus for receiving terminal capability information provided in an example of the present disclosure.

### DETAILED DESCRIPTION OF THE EMBODIMENTS

Examples of the present disclosure are further described in conjunction with the accompanying drawings and the detailed implementations.

The examples, whose illustrations are shown in the accompanying drawings, will be described in detail herein. Where the following descriptions involve the drawings, like numerals in different drawings refer to like or similar elements unless otherwise indicated. The implementations described in the following examples do not represent all implementations consistent with the embodiments of the present disclosure. Rather, they are merely examples of apparatuses and methods consistent with some aspects of the present disclosure as detailed in the appended claims.

The terms used in the present disclosure are for the purpose of describing particular examples only, and are not intended to limit the embodiments of the present disclosure. Terms determined by “a” and “the” in their singular forms used in the examples of the present disclosure and the appended claims are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” “third,” and the like may be adopted in the examples of the present disclosure to describe various information, such information should not be limited to these terms. These terms are only used to distinguish the information of the same type with each other. For example, without departing from the scope of the examples of the present disclosure, first information may be referred to as second information; and similarly, second information may also be referred to as first information. Depending on the context, the word “if” and “in case” as used herein may be interpreted as “when,” “upon,” or “in response to determining.”The following describes in detail the examples of the present disclosure. Illustrations of the examples are shown in the accompanying drawings, with the same or similar reference numerals referring to the same or similar elements throughout. The examples, which are described below with reference to the accompanying drawings, are illustrated and are intended to explain the present disclosure, but should not be construed as a limitation of the present disclosure.

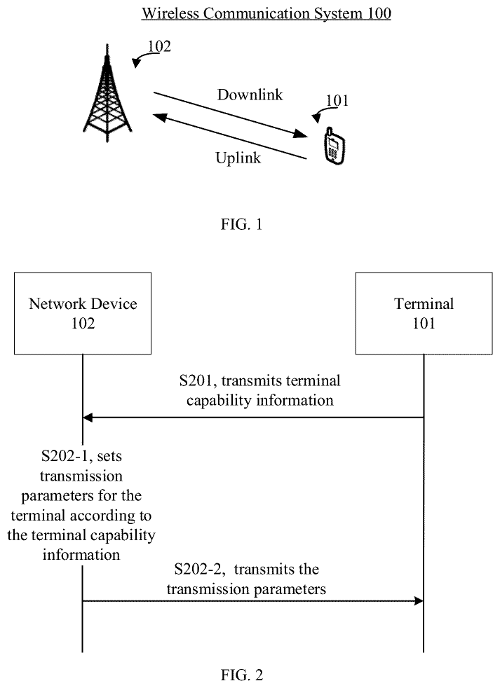

As illustrated in FIG. 1, a method for transmitting and receiving capability information provided by the examples of the present disclosure may be applied to a wireless communication system 100, which may include a terminal 101 and a network device 102. The terminal 101 is configured to support carrier aggregation. The terminal 101 may connect to multiple carrier units of the network device 102, including a primary carrier unit and one or more secondary carrier units.

It is to be understood that the wireless communication system 100 is applicable to both low-frequency scenarios and high-frequency scenarios. Application scenarios of the wireless communication system 100 include, but are not limited to, a long term evolution (LTE) system, a LTE frequency division duplex (FDD) system, a LTE time division duplex (TDD) system, a worldwide interoperability for micro wave access (WiMAX) communication system, a cloud radio access network (CRAN) system, a future fifth-generation (5G) system, a new radio (NR) communication system or a future evolved public land mobile network (PLMN) system, etc.

The illustrated terminal 101 may be a terminal, an access terminal, a terminal unit, a terminal station, a mobile station (MS), a remote station, a remote terminal, a mobile terminal, a wireless communication device, a terminal agent or a terminal device, etc. The terminal 101 may be equipped with a wireless transceiving function, and may perform communications (such as wireless communications) with one or more network devices of one or more communication systems, and receive network services provided by the network devices. The network device here includes, but is not limited to, the illustrated network device 102.

The terminal 101 may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a future 5G network, or a terminal device in a future evolved PLMN network, etc.

The network device 102 may be an access network device (or called an access network station). The access network device refers to a device that provides a network access function, for example, a radio access network (RAN) base station, etc. The network device 102 may specifically include a base station (BS), or include the base station and a radio resource management device for controlling base stations, etc. The network device 102 may also include a relay station (a relay device), an access point, a base station in the future 5G network, a base station in the future evolved PLMN network, or an NR base station, etc. The network device 102 may be a wearable device or a vehicle-mounted device. Alternatively, the network device may be a communication chip having a communication module.

For example, the network device 102 includes, but is not limited to, a next-generation base station (gNB) in 5G, an evolved node B (eNB) or a radio network controller (RNC) in an LTE system, a node B in a wide band code division multiple access (WCDMA) system, a radio controller or a base station controller (BSC) in a CRAN system, a base transceiver station (BTS) in a global system for mobile communications (GSM) system or a code division multiple access (CDMA) system, a home base station (for example, home evolved nodeB or home node B (HNB)), a baseband unit (BBU), a transmitting and receiving point (TRP), a transmitting point (TP) or a mobile switching center, etc.

The examples of the present disclosure provide a method for transmitting and receiving terminal capability information. FIG. 2 is a flowchart illustrating a method for transmitting and receiving terminal capability information according to an example. As illustrated in FIG. 2, the method includes steps S201 to S202 specifically.

At S201, a terminal transmits terminal capability information to a network device. The terminal capability information indicates whether the terminal supports a capability of transmitting multiple beams simultaneously.

Given that one antenna panel corresponds to one beam, it is to be noted that the capability of transmitting multiple beams simultaneously refers to a capability of the terminal to transmit multiple beams by multiple antenna panels simultaneously.

In some possible implementations, the terminal capability information is reported in a unit of band (i.e., per band) rather than in a unit of terminal (i.e., per UE). Therefore, when reporting information related to a specific band in frequency range 2 (FR2), it is possible to indicate to the network device that the terminal supports the capability of transmitting multiple beams simultaneously on the specific band in FR2.

In some possible implementations, the method for transmitting the terminal capability information from the terminal to the network device includes that the terminal transmits a signaling to the network device, and the signaling includes a first parameter that indicates whether the terminal supports simultaneous transmissions by multiple antenna panels. In an example, the signaling is MIMO-ParametersPerBand signaling.

In an example, the first parameter is IE simultaneousTransmissionByMulti-panel-r18. When the value of the parameter is set to 1, it means that the capability of transmitting multiple beams simultaneously is supported. When the value of the parameter is set to 0, it means that the capability of transmitting multiple beams simultaneously is not supported.

In some possible implementations, the method for transmitting the terminal capability information from the terminal to the network device includes that the terminal transmits a signaling to the network device, and the signaling includes a second parameter that indicates whether the terminal supports different spatial transmission parameters to be configured simultaneously. In an example, the signaling is MIMO-ParametersPerBand signaling.

In an example, the second parameter is IE simultaneous Transmission WithDiffTxSpatialParameter-r18. When the value of the parameter is set to 1, it means that the capability of transmitting multiple beams simultaneously is supported. When the value of the parameter is set to 0, it means that the capability of transmitting multiple beams simultaneously is not supported.

In some possible implementations, the spatial transmission parameters include at least one of the following parameters: spatial relationship information (SpatialRelationInfo), or a unified transmission configuration indicator (TCI).

Some network devices (such as the network devices supporting protocols after R17) support the unified TCI, and the other network devices (such as the network devices supporting protocols before R17) do not support the unified TCI. Therefore, during configuring spatial transmission parameters for the terminal, different spatial transmission parameters may be configured for the terminal simultaneously. In some possible implementations, the method further includes:
configuring two different TCIs for uplink signals of the terminal in a case that the unified TCI has been configured for the terminal by the network device, where the TCIs are joint TCIs or independent TCIs; and
configuring two different Quasi co-location (QCL) relationships for sounding reference signal (SRS) spatial relationship information of two uplink beams of the terminal in a case that no unified TCI is configured for the terminal by the network device, where the two different QCL relationships are both of type D.

Thus, the different spatial transmission parameters configured simultaneously are one case of the following:
the two different TCIs configured for uplink signals in the case that the unified TCI has been configured for the terminal by the network device, where the TCIs are the joint TCIs or the independent TCIs; or
the two different QCL relationships configured for the SRS spatial relationship information of two uplink beams in the case that no unified TCI is configured for the terminal by the network device, where the two different QCL relationships are both of type D.

At S202, the network device configures transmission parameters for the terminal according to the terminal capability information.

During setting the transmission parameters for the terminal according to the terminal capability information, the network device configures different transmission parameters for the terminal according to whether the terminal supports the capability of transmitting multiple beams simultaneously. Specifically, when the terminal supports a first capability, the transmission parameters corresponding to the capability of transmitting multiple beams simultaneously are configured for the terminal. When the terminal does not support the first capability, the transmission parameters corresponding to a capability of transmitting only one beam at the same time are configured for the terminal.

For example, the transmission parameter is beam indication information, and the beam indication information indicates two different QCL-D relationships to be simultaneously configured for the SRS spatial relationship information (spatialrelationinfo) of two uplink beams when the terminal supports the capability of transmitting multiple beams simultaneously. The transmission parameter is a number of data layers used for transmission, and the number of data layers used for transmission may be configured to 3 or 4 when the terminal supports the capability of transmitting multiple beams simultaneously, and only to 1 or 2 when the terminal does not support the capability of transmitting multiple beams simultaneously. Since the parameters, such as demodulation reference signals (DMRS) ports used for transmission and information that indicates precoding, are configured in a unit of the number of data layers, when the number of data layers used for transmission may be configured to 3 or 4, the corresponding number of DMRS ports and the corresponding number of information that indicates precoding are configured.

The S202, in which the network device configures the transmission parameters for the terminal according to the terminal capability information, includes two steps. The first step, S202-1, includes that the network device sets the transmission parameters for the terminal according to the terminal capability information. The second step, S202-2, includes that the network device transmits the transmission parameters to the terminal.

In the examples of the present disclosure, the terminal reports a terminal capability to the network device in a display mode or in an indication mode, so that the network device knows whether each terminal has the capability of transmitting multiple beams simultaneously. Therefore, the network device can configure the transmission parameters matching the terminal capability for the terminal, which improves scheduling effectiveness and saves network resources.

Based on the same concept as the method examples, the examples of the present disclosure also provide a communication apparatus. The communication apparatus may have the functions of the terminal 101 in the method examples and is configured to perform the step(s) performed by the terminal 101 provided in the foregoing examples. The functions may be implemented by hardware, or by corresponding software executed by hardware. The hardware or software includes one or more modules corresponding to the functions.

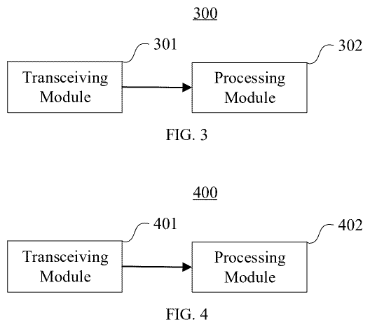

In a possible implementation, the communication apparatus 300 as illustrated in FIG. 3 may act as the terminal 101 involved in the method examples, and perform the step(s) performed by the terminal 101 in the method examples.

The communication apparatus 300 includes a transceiving module 301 and a processing module 302.

The transceiving module 301 is configured to transmit terminal capability information to a network device. The terminal capability information indicates whether the terminal supports a capability of transmitting a plurality of beams simultaneously.

In some possible implementations, the transceiving module 301 is further configured to transmit a signaling to the network device. The signaling includes a first parameter, and the first parameter indicates whether the terminal supports simultaneous transmissions on multiple antenna panels.

In some possible implementations, the transceiving module 301 is further configured to transmit a signaling to the network device. The signaling includes a second parameter, and the second parameter indicates whether the terminal supports different spatial transmission parameters to be configured simultaneously.

In some possible implementations, the processing module 302 is configured to: in a case that a unified TCI has been configured for the terminal by the network device, be configured with two different TCIs for uplink signals, where the TCIs are joint TCIs or independent TCIs; and
in a case that no unified TCI is configured for the terminal by the network device, be configured with two different QCL relationships for SRS spatial relationship information of two uplink beams, where the two different QCL relationships are both of type D.

The examples of the present disclosure also provide an electronic device, including one or more processors and one or more memories.

The one or more memories are configured to store a computer program.

The one or more processors are configured to execute the computer program to implement the methods perform by the terminal.

The examples of the present disclosure further provide a computer-readable storage medium. The computer-readable storage medium stores instructions. The instructions, when called and executed on a computer, causes the computer to perform the methods performed by the terminal.

Based on the same concept as the method examples, the examples of the present disclosure also provide a communication apparatus. The communication apparatus may have the functions of the network device 102 in the method examples and is configured to perform the step(s) performed by the network device 102 provided in the forgoing examples. The functions may be implemented by hardware, or by corresponding software executed by hardware. The hardware or software includes one or more modules corresponding to the functions.

In a possible implementation, the communication apparatus 400 as illustrated in FIG. 4 may act as the network device 102 involved in the method examples, and perform the step(s) performed by the network device 102 in the method examples.

The communication apparatus 400 includes a transceiving module 401 and a processing module 402.

The transceiving module 401 is configured to receive terminal capability information transmitted by a terminal. The terminal capability information indicates whether the terminal supports a capability of transmitting multiple beams simultaneously.

In some possible implementations, the transceiving module 401 is further configured to receive a signaling transmitted by the terminal. The signaling includes a first parameter, and the first parameter indicates whether the terminal supports simultaneous transmissions on multiple antenna panels.

In some possible implementations, the transceiving module 401 is further configured to receive a signaling transmitted by the terminal. The signaling includes a second parameter, and the second parameter indicates whether the terminal supports different spatial transmission parameters to be configured simultaneously.

In some possible implementations, the processing module 402 is further configured to configure the different spatial transmission parameters for the terminal simultaneously.

In some possible implementations, the processing module 402 is further configured to configure two different TCIs for uplink signals of the terminal in a case that a unified TCI has been configured for the terminal by the network device, where the TCIs are joint TCIs or independent TCIs. The processing module 402 is further configured to configure two different QCL relationships for SRS spatial relationship information of two uplink beams of the terminal in a case that no unified TCI is configured for the terminal by the network device, where the two different QCL relationships are both of type D.

The examples of the present disclosure also provide an electronic device, including one or more processors and one or more memories.

The one or more memories are configured to store a computer program.

The one or more processors are configured to execute the computer program to implement the methods perform by the network device.

The examples of the present disclosure also provide a computer-readable storage medium. The computer-readable storage medium stores instructions. The instructions, when called and executed on a computer, cause the computer to perform the methods performed by the network device.

The examples of the present disclosure also provide a system for transmitting and receiving terminal capability information, including the terminal and the network device.

Other implementations of the examples of the present disclosure will be readily apparent to those skilled in the art after implementing the present disclosure by referring to the description. The present disclosure is intended to cover any variations, uses, or adaptations of the examples of the present disclosure that are in accordance with the general principles thereof and include common general knowledge or conventional technical means in the art that are not disclosed in the present disclosure. The description and the examples are only illustrative, and the scope and spirit of the examples of the present disclosure are to be indicated by appended claims.

It is to be understood that the examples of the present disclosure are not limited to the precise structures described above and illustrated in the accompanying drawings, and that various modifications and changes may be made without departing from the scope thereof. The scope of the examples of the present disclosure is limited only by the appended claims.

### INDUSTRIAL PRACTICALITY

Terminals report a terminal capability to a network device, so that the network device knows whether each terminal has a capability of transmitting multiple beams simultaneously. Therefore, the network device can configure transmission parameters matching the terminal capability for the terminal, which improves scheduling effectiveness and saves network resources.

1. A method for transmitting terminal capability information, performed by a terminal, the method comprising:
transmitting terminal capability information to a network device, wherein the terminal capability information indicates whether the terminal supports a capability of transmitting a plurality of beams simultaneously.

2. The method according to claim 1, wherein transmitting the terminal capability information to the network device comprises:
transmitting a signaling to the network device, wherein the signaling comprises a first parameter, and the first parameter indicates whether the terminal supports simultaneous transmissions by a plurality of antenna panels.

3. The method according to claim 1, wherein transmitting the terminal capability information to the network device comprises:
transmitting a signaling to the network device, wherein the signaling comprises a second parameter, and the second parameter indicates whether the terminal supports different spatial transmission parameters to be configured simultaneously.

4. The method according to claim 3, further comprising: being configured with two different transmission configuration indicators (TCIs) for uplink signals, wherein the TCIs are joint TCIs or independent TCIs, and wherein a unified TCI has been configured for the terminal by the network device; and
being configured with two different Quasi co-location (QCL) relationships for sounding reference signal (SRS) spatial relationship information of two uplink beams, wherein the two different QCL relationships are both of type D, and wherein no unified TCI is configured for the terminal by the network device.

5. A method for receiving terminal capability information, performed by a network device, the method comprising:
receiving terminal capability information transmitted by a terminal, wherein the terminal capability information indicates whether the terminal supports a capability of transmitting a plurality of beams simultaneously.

6. The method according to claim 5, wherein receiving the terminal capability information transmitted by the terminal comprises:
receiving a signaling transmitted by the terminal, wherein the signaling comprises a first parameter, and the first parameter indicates whether the terminal supports simultaneous transmissions by a plurality of antenna panels.

7. The method according to claim 5, wherein receiving the terminal capability information transmitted by the terminal comprises:
receiving a signaling transmitted by the terminal, wherein the signaling comprises a second parameter, and the second parameter indicates whether the terminal supports different spatial transmission parameters to be configured simultaneously.

8. The method according to claim 7, wherein the method further comprises:
configuring the different spatial transmission parameters for the terminal simultaneously.

9. The method according to claim 8, further comprising:
configuring two different transmission configuration indicators (TCIs) for uplink signals of the terminal, wherein the TCIs are joint TCIs or independent TCIs, and wherein a unified TCI has been configured for the terminal by the network device; and
configuring two different Quasi co-location (QCL) relationships for sounding reference signal (SRS) spatial relationship information of two uplink beams of the terminal, wherein the two different QCL relationships are both of type D, and wherein no unified TCI is configured for the terminal by the network device.

10.-11. (canceled)

12. A communication device, comprising:
one or more processors; and
one or more memories that store a computer program;
wherein the computer program when collectively executed by the one or more processors causes the communication device to:
act as a terminal, and
transmit terminal capability information to a network device, wherein the terminal capability information indicates whether the terminal supports a capability of transmitting a plurality of beams simultaneously.

13. A communication device, comprising:
one or more processors; and
one or more memories that store a computer program;
wherein the computer program when collectively executed by the one or more processors causes the communication device to act as the network device and perform the method according to claim 5.

14. A non-transitory computer-readable storage medium, in which instructions are stored, wherein the instructions, when called and executed by one or more processors of the terminal, cause the terminal to perform the method according to claim 1.

15. A non-transitory computer-readable storage medium, in which instructions are stored, wherein the instructions, when called and executed by one or more processors of the network device, cause the network device to perform the method according to claim 5.

16. (canceled)

17. The communication device according to claim 12, wherein the computer program when collectively executed by the one or more processors further causes the communication device to:
transmit a signaling to the network device, wherein the signaling comprises a first parameter, and the first parameter indicates whether the terminal supports simultaneous transmissions by a plurality of antenna panels.

18. The communication device according to claim 12, wherein the computer program when collectively executed by the one or more processors further causes the communication device to:
transmit a signaling to the network device, wherein the signaling comprises a second parameter, and the second parameter indicates whether the terminal supports different spatial transmission parameters to be configured simultaneously.

19. The communication device according to claim 18, wherein the computer program when collectively executed by the one or more processors further causes the communication device to:
be configured with two different transmission configuration indicators (TCIs) for uplink signals, wherein the TCIs are joint TCIs or independent TCIs, and wherein a unified TCI has been configured for the terminal by the network device; and
be configured with two different Quasi co-location (QCL) relationships for sounding reference signal (SRS) spatial relationship information of two uplink beams, wherein the two different QCL relationships are both of type D, and wherein no unified TCI is configured for the terminal by the network device.

20. The communication device according to claim 13, wherein the computer program when collectively executed by the one or more processors further causes the communication device to:
receive a signaling transmitted by the terminal, wherein the signaling comprises a first parameter, and the first parameter indicates whether the terminal supports simultaneous transmissions by a plurality of antenna panels.

21. The communication device according to claim 13, wherein the computer program when collectively executed by the one or more processors further causes the communication device to:
receive a signaling transmitted by the terminal, wherein the signaling comprises a second parameter, and the second parameter indicates whether the terminal supports different spatial transmission parameters to be configured simultaneously.

22. The communication device according to claim 21, wherein the computer program when collectively executed by the one or more processors further causes the communication device to:
configure the different spatial transmission parameters for the terminal simultaneously.

23. The communication device according to claim 22, wherein the computer program when collectively executed by the one or more processors further causes the communication device to:
configure two different transmission configuration indicators (TCIs) for uplink signals of the terminal, wherein the TCIs are joint TCIs or independent TCIs, and wherein a unified TCI has been configured for the terminal by the network device; and
configure two different Quasi co-location (QCL) relationships for sounding reference signal (SRS) spatial relationship information of two uplink beams of the terminal, wherein the two different QCL relationships are both of type D, and wherein no unified TCI is configured for the terminal by the network device.
